(19) United States
(12) Patent Application Publication
(10) Pub. No.: US 2005/0272021 A1
(43) Pub. Date: Dec. 8, 2005

(54) Method of multi-level analyzing personal learning capacity

(75) Inventor: Jenn-Cheng Yu, Tali City (TW)

Correspondence Address: BINGHAM, MCCUTCHEN LLP, THREE EMBARCADERO CENTER, 18 FLOOR, SAN FRANCISCO, CA, 94111-4067, US

(73) Assignee: Education Learning House Co., Ltd., Tali City (TW)

(21) Appl. No.: 10/859,094

(22) Filed: Jun. 3, 2004

(51) Int. Cl. G09B 3/00; G09B 7/00

(52) U.S. Cl. 434/322; 434/323; 434/362

(57) ABSTRACT

A method of multi-level analyzing personal learning capacity mainly has a first and second question levels. The first question level is used to provide a user multiple questions of lessons with difficulty levels and records the questions incorrectly answered by the user. The second question level is further to provide the user questions of the lessons having the questions incorrectly answered at the first question level. If the user still incorrectly answers the questions provided by the second question level, the method will determine learning capacities of the lessons as “low level”. If the user correctly answers the questions provided by the second question level, the method will determine learning capacities of the lessons as “middle level”.

### BACKGROUND OF THE INVENTION

1. Field of the Invention

The present invention relates to a method of analyzing personal learning capacity, and more specifically to a multi-level analyzing method for personal learning capacity that provides a user an analysis list that discloses different learning levels for lessons.

2. Description of Related Art

In many countries, students have large education loads so they often go to supplementary classes at the end of the conventional school day and on weekends. The school classes or supplementary classes are education systems, each of which consists of one teacher and many students. Some students can not adapt to these education systems so they usually have a private tutor at home to study lessons, find learning disorders for specific lessons of courses and provide those specific lessons to make their study results better. However, not everyone can afford the private tutor because the one-to-one nature of such private tuition is so costly. Of course, the upside of the private tutor is that as only one student receives the undivided attention of the tutor, so the student's learning disorders could be found and focussed on.

According to Taiwan Patent 371341, a language testing method that is built in a computer is disclosed. The patent mainly has the following steps:
(a) Creating a test database in the computer;
(b) Judging a user's learning level according to the user's grade in school;
(c) Providing the test with one question about language according to the user's grade;
(d) Recording the results and testing processes in a storage device to make a test track list;
(e) Analyzing the learning capacity of the user via the test track list and providing a statement of judgment for the present test; and
(f) Providing the user an advanced test to increase the user's learning capacity.

The patent provides a test method for language by the computer to help the student find the learning disorder in a language course. However, the patent has failed to provide an accurate personal learning capacity function since the patent has to identify the grade of the user. For example, one student in the fourth grade in school could have only a learning capacity of the language in third, or second, or even first grade. If the computer provides the user a question for the fourth grade, the user could never find his learning disorder in the language course. In addition, a single question provided to the user by the computer is not sufficient for judging the learning capacity of the anguage. Briefly, the test method is not suitable for all students.

To overcome the shortcomings, the present invention provides a multi-level analyzing method for personal learning capacity to mitigate or obviate the aforementioned problems.

### SUMMARY OF THE INVENTION

An objective of the present invention is to provide a multi-layer analysis method for personal learning capacity that provides a high accuracy analysis result for personal learning capacity. A user could enhance study time for the specific lessons according to the analysis result.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a computer where a multi-level analysis method is built in accordance with the present invention;

FIG. 2 is a list including questions, answers, and difficulty levels of lessons in two Q&A databases in accordance with the present invention;

FIG. 3 is a result list provided by the multi-level analysis method in accordance with the present invention; and

FIGS. 4A and 4B are flow charts of the multi-level analysis method in accordance with the present invention.

### DETAILED DESCRIPTION OF THE PREFERRED EMBODIMENT

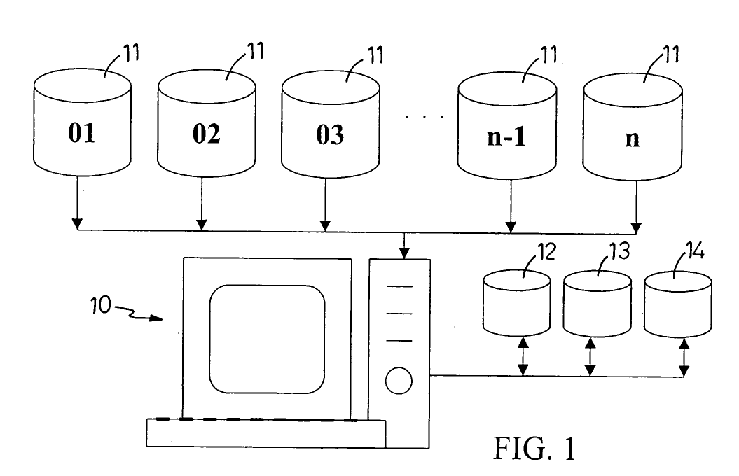

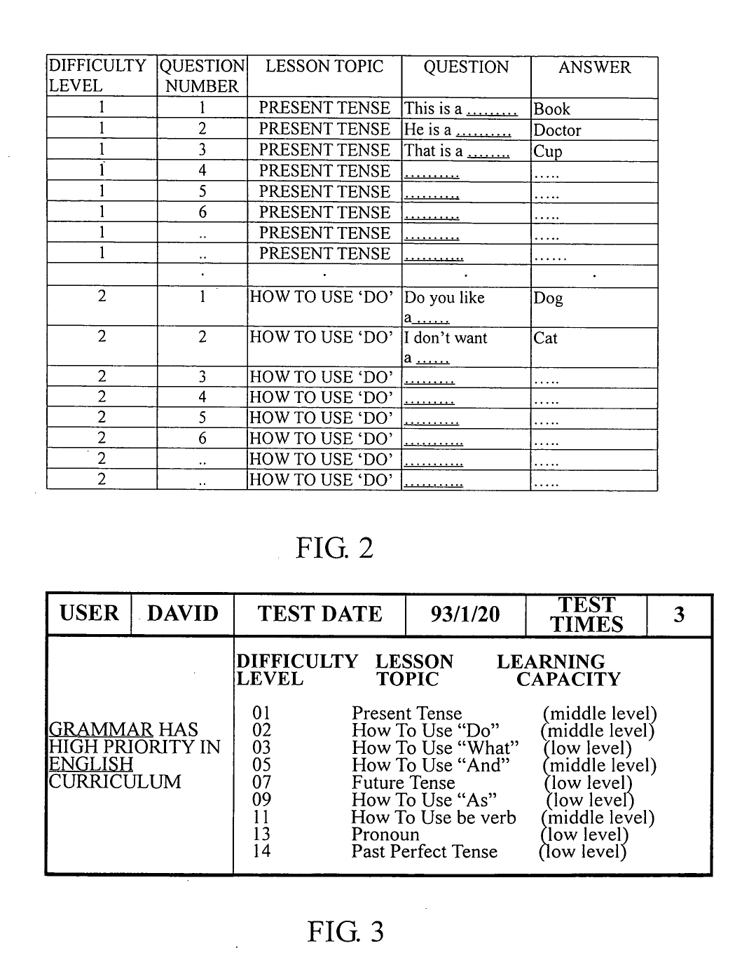

With reference to FIG. 1, the present invention is related to a learning capacity analyzing method built in a computer. The computer has a first, a second, a third and a fourth accumulative registers (not shown) and also builds a first, a second and a third storage databases (12, 13, 14) and multiple question-and-answer (Q&A) databases (11), each of which stores questions, answers and related digital data of different lessons of many courses, such as Chinese, English, Mathematics, Chemistry etc. One course has base lessons, middle lessons, and advanced lessons. These lessons of each course have different difficulty levels so the Q&A databases (11) respectively store a specific difficulty level lesson's questions. With reference to FIG. 2, the digital data of each Q&A database (11) includes one difficulty level, question quantities and lesson topics.

The multi-level analysis method comprises:
(a) creating multiple Q&A databases (11) which respectively store different difficulty level lesson's questions and answers corresponding to the questions, and each of which has a unique difficulty level;
(c) setting a first quantity of the questions stored in each Q&A database, and a second quantity of the questions incorrectly answered by the user, wherein the first quantity of the questions defines how many questions in each Q&A database should be provided to a user, and the second quantity of the questions incorrectly answered defines how many wrong answers the user can make;
(d) a first question level; and
(e) a second question level.

The first question level is mainly used to provide the user questions from the Q&A databases in sequence from the low difficulty level to high difficulty level, until the quantity of the questions incorrectly answered are equal to the second quantity. The difficulty levels corresponding to the questions incorrectly answered are stored in a first storage database (12).

The second question level is mainly used to provide the user the questions according to the difficulty levels stored in the first storage database (12) until the quantities of the questions of all Q&A databases according to the difficulty levels are equal to the preset number. The second storage database (13) stores the difficulty levels of the questions correctly answered and the third storage database (14) stores the difficulty levels of the questions incorrectly answered. The computer (10) reads the difficulty levels stored in the second database (12), displays the lesson topics corresponding to the difficulty levels in the second database (12), and notes a judgment “middle level” next to the lesson topics. The computer (10) also reads the difficulty levels in the third storage database (14), displays the lesson topics corresponding to the difficulty levels and notes a judgment “low level” next to the lesson topics.

The present invention mainly allows the user to take the test two or more times. If the user gave the wrong answer for the questions provided by the computer (10) in the same difficulty level Q&A database (11) at the first and second question levels, the computer (10) will determine the user's learning capability for the specific lesson with this difficulty level is “low level”. If the user gave the correct answer for the questions provided by the computer in the same difficulty level Q&A database (11) at second time, the computer (10) will determine the user's learning capability of the difficulty level lesson is “middle level”. If the user gave the correct answer for the questions provided by the computer (10) at the first question level, the computer (10) will not show any judgment for the specific lessons corresponding to the questions correctly answered at the first and second levels.

Therefore, the user can easily understand which difficulty level lessons should be studied more or less.

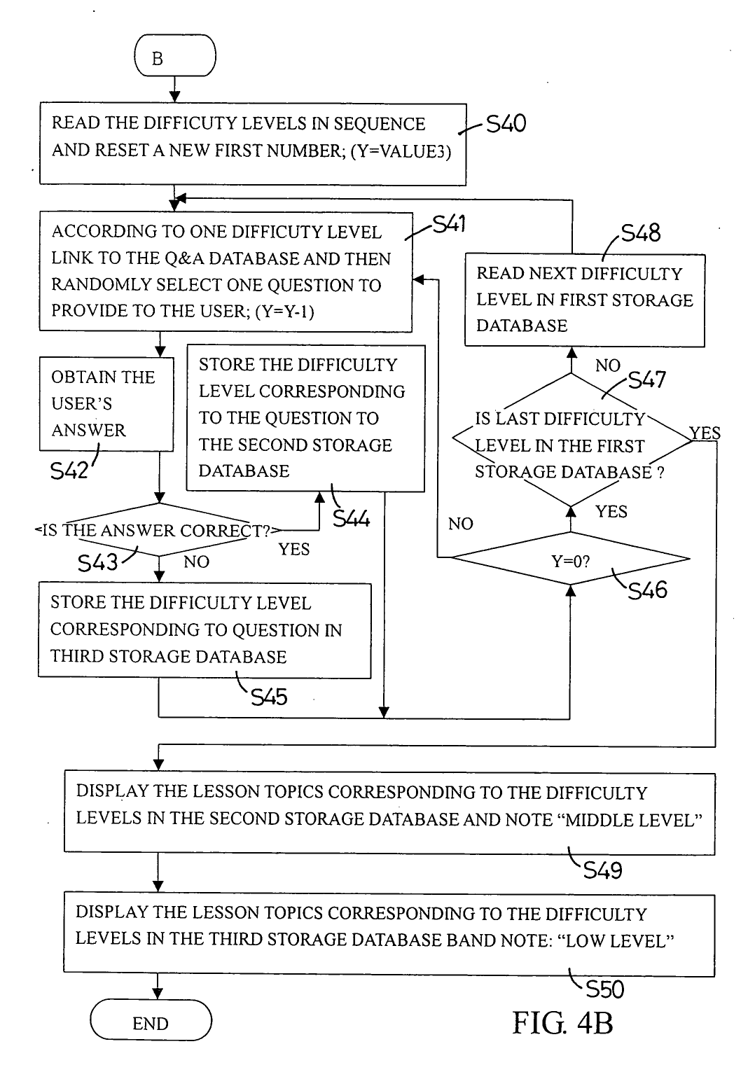

FIGS. 4A and 4B show detailed flowcharts of the above multi-level analysis method. With further reference to FIG. 1, each Q&A database (11) stores the many different courses' lessons so the computer (10) will receive one specific course that is selected by the user (S30). After the computer (10) receives the specific course, the computer (10) starts to initiate following steps of (S31):
(a) setting a first accumulative register N which is equal to 1 (N=1;), wherein the N is used to represent the present difficulty level;
(b) setting a second accumulative register X which is equal to 0 (X=0;), wherein the X is used to count the quantity of the wrong answers;
(c) setting a third accumulative register Y which is equal to the first quantity (Y=VALUE1;), wherein the Y is used to represent the first quantity of the questions of each Q&A database provided to the user; and
(d) setting a fourth accumulative register Z which is equal to the second quantity (Z=VALUE2;), wherein the Z is used to store the second quantity of the questions wrongly answered by the user.

The computer (10) starts to randomly select a question from the difficulty level Q&A database (11) in sequence (S32), provides the user the question and counts down the third accumulative register Y (S33). When the computer (10) receives the answer from the user (S34), the computer (10) will check whether the answer is correct or not (S35). If the answer is wrong the computer (10) will record the difficulty level corresponding to the question with wrong answer in the first storage database (12)(S36). If the answer is correct, the computer (10) will repeat to select randomly another question in the present N difficulty level Q&A database (11) until the Y is equal to 0, or the X is equal to Z (S37).

If the Y is equal to 0 (S38) and the X is not equal to the VALUE2, the difficulty level N will be added 1 (S39). That is, the computer (11) will start to select questions from the next difficulty level Q&A database in sequence.

With reference to FIG. 4B, if the X is equal to Z, the computer (10) reads the difficulty levels recorded in the first storage database in sequence and starts to reset a new quantity of the questions provided to the user to Y register (Y=VALUE3)(S40). The computer (10) starts to randomly select the question from the first difficulty level Q&A database (11), provides the user the selected question and counts down the Y (Y=Y−1)(S41). After the computer (10) obtains the answer made by the user (S42), the computer (10) will check the correctness of the answer (S43). If the answer is correct, the difficulty level corresponding to the present question will be recorded to the second storage database (13) (S44). If the answer is wrong, the difficulty level corresponding to the present question will be recorded to the third storage database (14) (S45).

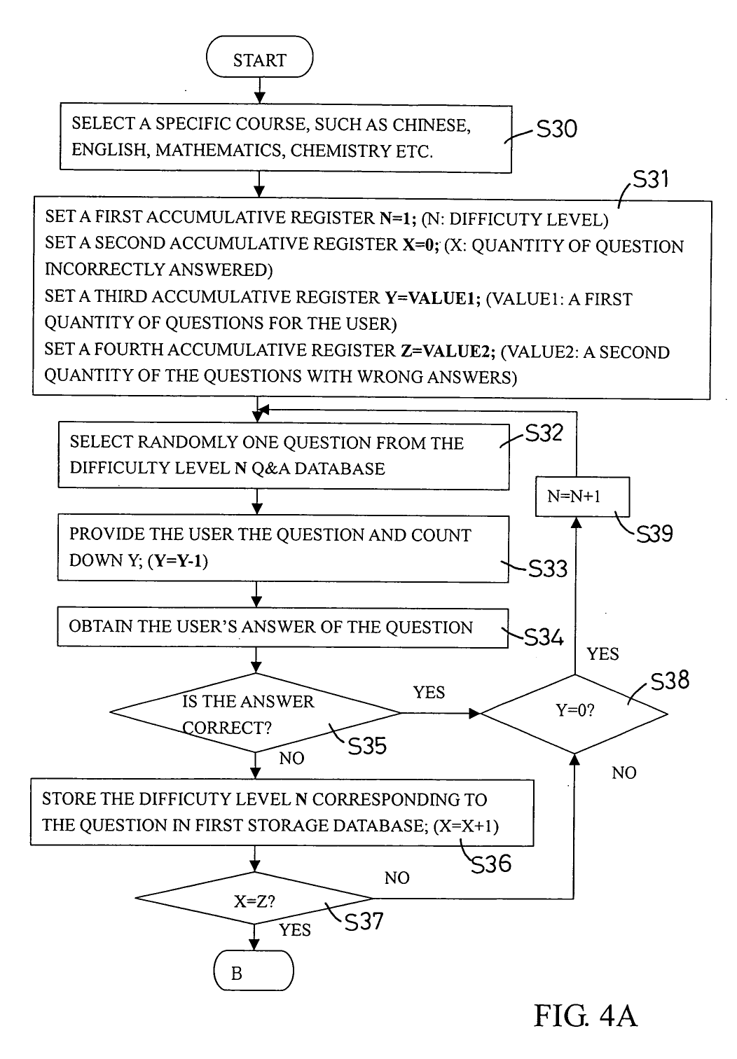

With further reference to FIG. 3, a result list of learning capacity for the user is displayed by the computer (10). That is, when the computer (10) provides the user enough questions of all difficulty level Q&A databases (11) according to the difficulty levels in the first storage database (12) (S46˜S48), the computer (10) first reads the difficulty levels in the second storage database (13) in sequence. Then the computer (10) displays the lesson topics corresponding to the difficulty levels in the second storage database (13), and notes the judgment “middle level” next to the lesson topics (S49). The computer (10) further reads the difficulty levels of the third storage database (14), displays the lesson topics corresponding to the difficulty levels in the third storage database (14) and displays the judgment “low level” next to the lesson topics (S50).

With reference to FIG. 2, the questions for the lessons of English course are created and stored in correspondence with the difficulty level Q&A database. FIG. 2 shows the questions for the lesson topic “present tense” created to the first difficulty level Q&A database, and the questions for the lesson topic “How to Use ‘do’” are created to the second difficulty level Q&A database. With further reference to FIG. 3, the user selects the English course to analyze the learning capacity for the English course. The result list shows the user's learning capacity for the lessons of the English course, so the user can study these lessons shown on the result list.

The result list further displays the user's name, test date, and the times of test for the same user. The user can understand which lessons should be studied in a specific course, since the computer provides the questions from low to high difficulty level. That is, the result list provided by the computer is more accurate than the prior arts. Therefore, students can have a private tutor-like analysis method to help find the their learning disorders for each course.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method of multi-level analyzing personal learning capacity comprising:
(a) creating multiple question-and-answer (Q&A) databases which respectively store different difficulty level questions and answers corresponding to the questions, and each of which has a unique difficulty level;
(c) setting a first quantity of the questions stored in each question-and-answer database, and a second quantity of the questions incorrectly answered by the user, wherein the first quantity of the questions defines how many questions in each Q&A database are provided to a user, and the second quantity of the questions incorrectly answered defines the limit to incorrect answers the user make;
(d) a first question level providing the user with questions from the Q&A databases in sequence from the low difficulty level to high difficulty level, until the quantities of the questions incorrectly answered are equal to the second quantity; and
(e) a second question level providing questions from the Q&A databases according to the difficulty levels for the questions incorrectly answered at the first question level, wherein
if the questions provided at the second question level are correctly answered, a learning capacity of the lessons corresponding to the questions correctly answered are determined to a middle level; and
if the questions provided at the second question level are incorrectly answered, a learning capacity of the lessons corresponding to the questions incorrectly answered are low level.

2. The method as claimed in claim 1, wherein the method is built in a computer mainly having a first, second and third storage databases, wherein the first question level has steps of:
providing the user one question from one Q&A database; and
checking the correctness of answer for the provided question, wherein the difficulty levels corresponding to the questions incorrectly answered are stored in the first storage database;
checking whether quantities of the question are equal to the first quantity, wherein if the quantity is equal to the first question, the computer links to the next Q&A database according to the difficulty level in sequence and then goes to the first step; and if not, the computer goes to the first step; and
checking whether quantities of the questions incorrectly answered are equal to the second quantity, wherein if the quantity of the questions incorrectly answered are equal to the second quantity, the computer will go to the second question level; and if not, the computer will go to the first step.

3. The method as claimed in claim 2, wherein the second question level has steps of:
reading the difficulty levels stored in the first storage database in sequence from low to high difficulty level;
resetting a new first quantity;
providing one question from one Q&A database according to one difficulty level in the first storage database;
checking correctness of an answer for the provided question, wherein the difficulty levels corresponding to the questions correctly answered are stored in the second storage database, and the difficulty levels corresponding to the questions with the incorrectly answered are stored in the third storage database; and
checking whether quantity of the questions is equal to the new first quantity, wherein if the quantity is equal to the new first quantity, the computer links to the next Q&A database according to the difficulty level in sequence and then goes to the first step; and if not, the computer goes to the third step.

4. The method as claimed in claim 1, wherein in the first and second question levels, the questions are selected randomly.

5. The method as claimed in claim 2, wherein in the first and second question levels, the questions are selected randomly.

6. The method as claimed in claim 3, wherein in the first and second question levels, the questions are selected randomly.
